(19) United States
(12) Patent Application Publication
(10) Pub. No.: US 2008/0150971 A1
(43) Pub. Date: Jun. 26, 2008

(54) METHOD FOR THE OPERATION OF A DISPLAY DEVICE WITH A PLURALITY OF WEAR-AFFLICTED PICTURE ELEMENTS AND DISPLAY DEVICE

(75) Inventor: Carsten Kienhoefer, Karlsruhe (DE)

Correspondence Address: BRINKS HOFER GILSON & LIONE, P.O. BOX 10395, CHICAGO, IL, 60610, US

(73) Assignee: Ingenieurbuero Kienhoefer GmbH, Karlesruhe (DE)

(21) Appl. No.: 12/041,184

(22) Filed: Mar. 3, 2008

Related U.S. Application Data
(63) Continuation of application No. PCT/EP2006/007778, filed on Aug. 5, 2006.

(30) Foreign Application Priority Data
Sep. 1, 2005 (DE) DE 102005042704.9

(51) Int. Cl. G09G 5/10

(52) U.S. Cl. 345/690

(57) ABSTRACT

A method for operating a display device having a plurality of wear-afflicted picture elements is provided. Each picture element is acted upon by a control signal assigned to it. A wear value for at least one picture element is determined, the wear value being a measure of the wear of the picture element. The wear value is determined as a function of at least one of the following: the temperature of the picture element and the temperature of at least one adjacent picture element.

### CROSS-REFERENCE TO RELATED APPLICATIONS

This application is a continuation of International Application No. PCT/EP2006/007778 filed on Aug. 5, 2006, which claims the benefit of DE 10 2005 042 704.9, filed Sep. 1, 2005. The disclosures of the above applications are incorporated herein by reference.

### FIELD

The present invention relates to a method of operating a display device with a plurality of wear-afflicted picture elements, and further, the present invention relates to a display device with a plurality of wear-afflicted picture elements.

### BACKGROUND

The statements in this section merely provide background information related to the present disclosure and may not constitute prior art.

A first undesired effect in the operation of a plasma screen is the so-called burn-in effect, which is already known from CRT monitors, and in which the electrical/optical conversion efficiency of an illuminant comprising phosphorous compounds is reduced, in particular in picture elements of the plasma screen in which the same bright image, for example a logo superimposed to a TV image, is displayed for a long time. The result is that the superimposed logo displayed for a long time, for example, can also be seen in the form of a contrast difference with respect to the other regions or picture elements of the plasma image when the logo is in fact no longer being displayed in the TV image.

A further undesired effect in the operation of a plasma screen is that with color screens, the different illuminants assigned to each particular primary color age at different rates, so that undesired changes in the color display, for example an orange tint, occur over the lifetime of a color screen of this type.

Methods for the operation of display devices are used with plasma screens, for example, in order to counteract or to compensate for wear phenomena, for example, the aging of the phosphorous components used as illuminants. Further, such methods are also used in displays with organic light emitting diodes (OLED), in displays operating on a field emission principle (FED), in NED (nano-emissive display) displays that use carbon nanotubes, or in other displays that feature wear-afflicted picture elements.

Wear values can be used to compensate for the wear phenomena of the displays described above. Currently, wear values are determined by specifically modifying and/or correcting a control signal controlling the display device on the basis of a determined wear value, so that the corresponding picture elements of the display device emit image signals of the desired brightness despite the reduced electrical/optical conversion efficiency.

### SUMMARY

The present invention provides a method and device in which each picture element is acted upon with its assigned control signal, and in which a wear value is determined for at least one picture element as a measure of the wear of the picture element.

In one form, a method of the present invention includes determining the wear value of a picture element as a function of the temperature of the picture element and/or as a function of the temperature of at least one adjacent picture element. The consideration of the temperature of a picture element and/or of adjacent picture elements accounts for the fact that the initially described wear effects not only depend on the control signal, by means of which the particular picture element is activated, but also on the temperature at which the picture element is operated, or which the picture element is exposed to. As a result, a more precise determination of wear values is possible in comparison with conventional methods.

In this connection, it should be kept in mind that in terms of the present invention a pixel may contain several picture elements in color displays, in particular three picture elements, which correspond to the respective primary colors red, green, and blue. In the case of a monochrome display, a pixel exactly corresponds to one picture element. Since the thermal effect of adjacent picture elements on one another is more or less independent of what primary color a corresponding picture element is assigned to, no distinction need necessarily be drawn among picture elements of different primary colors for the implementation of the method according to the present invention.

For example, to determine the wear value of a picture element under consideration, the thermal effect of those picture elements that are assigned to the same pixel as the picture element under consideration as well as the thermal effect of individual or several picture elements of one or several adjacent pixels may be taken into account.

In some forms, the temperature of the picture element and/or of the adjacent picture elements may be determined as a function of the control signal. In particular with plasma screens, there is a correlation between the control signal and the thermal energy that is delivered to the picture element by the activation with this control signal.

Namely, the picture element of a plasma screen is activated, for example, in that by means of a so-called plasma pulse generator a local electrical discharge is produced in the each picture element, which along with the desired illumination, also contributes to the heating of the picture element or of the plasma display cell forming the picture element. Knowing and/or estimating the heat capacity of this cell, and with a known pulse sequence, i.e. with a known activation signal of the picture element, the heat supply to the picture element can accordingly be determined on the basis of the activation with the control signal. For example, a picture element heats up more intensely the brighter the activation is set, that is, the longer the phase of the switched-on state.

In another form of the method according to the present invention, the contribution of the adjacent picture elements to the temperature of the picture element and/or to its wear value may be determined in the form of a weighted sum of the temperatures of the adjacent picture elements. In this way, a comparatively simple calculated estimate of the heat conduction process within the display device is provided, so that in particular no differential equations have to be used to calculate the temperature distribution among the different picture elements.

To form the weighted sum described above, weighting factors may be used that are a function of: a) the distance of the picture element from the particular adjacent picture element, b) the substrate on which the picture elements are arranged and/or the physical properties of the substrate, in particular of the heat conductivity of the substrate, c) the temperature of a picture element and/or the adjacent picture elements, and/or d) the position of the picture element.

Depending on the type of arrangement of the picture elements within the display device, adjacent picture elements feature different distances from one another, which consequently may be considered by selecting suitable weighting factors.

Further, the heat conductivity of the substrate holding the picture elements may be considered in particular by modifying the weighting factors. Other properties or influences of the substrate may also be represented by the weighting factors. It is likewise possible to include a temperature difference between adjacent picture elements by means of the weighting factors.

Furthermore, it may be convenient to take the absolute position of the picture element in the display device into account, for example, in order to include special conditions in connection with the heat conduction, particularly along the edge of the display device, or in the corners, when determining the temperature of a picture element according to the present invention.

In yet another form, the wear value of a picture element may be determined as a function of the temperature of the display device and/or as a function of the ambient temperature.

Furthermore, the weighting factors used in the formation of the weighted sum may be selected as a function of the ambient temperature and/or of the temperature, which for example can be measured inside the housing of the display device for the entire display device and/or cooling of the display device.

The display device may be cooled by fans distributed over the display region or by special ventilation channels, for example, inside which an air stream provided for cooling is passed over the display region of the display device. Further, a direct, effective heat conducting contact of the picture elements with a filter disk covering the display region may be provided, as a result of which especially uniform cooling of the picture elements may be achieved if the filter disk convects the heat from the picture elements to the environment.

Depending on the design of the cooling system, the applied weighting factors may be modified, for example to allow for the removal of the heat into the environment in zones of the display device directly supplied with cool air by a fan. For regions of the display device not directly supplied with such an air stream, other weighting factors may be selected accordingly.

A single weighting factor may be determined as the product of different factors, for example, with which each factor may represent one of the above factors that describe the heat transport from picture element to picture element.

Further, the method may include determining the temperature of the display device and/or the ambient temperature when the display device is not in operation, that is, when it is deactivated, because the temperature-dependent wear of the picture elements or the chemical compound contained therein, like the organic compounds used in the OLED systems, for example, is also present when the display device is not in operation. The method may also include determining the duration of the phases during which the display device is not in operation, that is, when it is deactivated. By also taking the temperature of the display device and/or the ambient temperature into account during those phases, during which the display device is not in operation, a further increase in the precision of the wear value determination may be achieved.

In still another form, a common wear value may be determined for several picture elements. With this measure, the number of wear values which have to be determined for a display device decreases, so that a lower memory bandwidth and memory size or calculating power is required to process the wear values, and thus more cost effective devices can be produced to operate the display device.

For example, instead of determining a specific wear value for each picture element, it is conceivable to determine a common wear value for four adjacent picture elements. In this case, the number of wear values to be processed is reduced to one quarter.

In still another form, a common wear value as a function of the control signals assigned to the various picture elements may be determined. In particular, it is conceivable to determine the common wear value as the sum of those control signals that are assigned to the individual picture elements to which the common wear value corresponds.

In still another form, an image displayed on the display device may be shifted periodically in accordance with a predefinable sequence of shift steps. Cyclic shifting of the image prevents, for example, the picture elements with especially bright activation from being too intensely worn because, depending on the predefinable sequence of shift steps, the corresponding activation signal is sent to adjacent picture elements for example, and the stress and/or wear from bright activation is thus distributed among several picture elements. The method may include applying the technology basically known by the term “orbiter” or “panning” to determine common wear values.

Preferably, after executing all shift steps of the predefinable sequence, the image is again at its original position on the display device.

In still another form, the method includes providing pauses between the execution of two sequential shift steps. The pauses may range from 1 second to 3600 seconds, by way of example. In one form, the pauses may be approximately 10 seconds. Pauses of around 10 seconds between two successive shift steps are not perceived by an observer, so that the overall impression of an image shown by the display device is not affected by the shifting according to the present invention.

In some forms, the method provides the sequence of shift steps comprising the following sequence: a) shifting the image by a predefinable number of pixels (for example, one pixel) in a first direction, b) shifting the image by a predefinable number of pixels (for example, one pixel) in a second direction, c) shifting the image by a predefinable number of pixels (for example, one pixel) in a third direction, and d) shifting the image by a predefinable number of pixels (for example, one pixel) in a fourth direction. It should be kept in mind that a pixel in terms of the present invention may contain several picture elements in color displays, in particular three picture elements, which correspond to the respective primary colors red, green, and blue. In the case of a monochrome display, one pixel exactly corresponds to one picture element.

In some forms, a common wear value may be assigned to three picture elements that define different primary colors of a pixel. Further, a common wear value may be assigned to several such 3-tuples of picture elements, which each form their own full-color pixel.

In a color display, a common wear value may be assigned to each of those picture elements of adjacent pixels that contribute to the formation of the same primary color. That is, with four adjacent pixels, for example, each with three picture elements for the formation of the respective primary colors, a total of three common wear values may be used, whereby each of the three common wear values is assigned to one of the primary colors red, green, and blue, and whereby the respective four picture elements of the corresponding primary color of the adjacent pixels contribute to one of the common wear values.

In another form, a method is provided for the recognition of still images, wherein the common wear value is determined as a function of the control signals assigned to the various picture elements (R0, R1, R2, . . . ).

In yet another form, a display device is provided that is shifted periodically in accordance with a predefinable sequence of shift steps. After the performance of all the shift steps of the predefinable sequence, the image is preferably again at its original position on the display device (150).

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of four pixels of a display device according to the present invention;

FIG. 2 is a flow diagram of a method according to the present invention;

FIG. 3 is a schematic illustration of a display device according to the present invention;

FIG. 4 is a schematic illustration of the division of a picture of the display device of FIG. 3 into several picture regions; and

FIG. 5 is a flow diagram of another method according to the present invention.

### DETAILED DESCRIPTION

The following description is merely exemplary in nature and is not intended to limit the present disclosure, application, or uses.

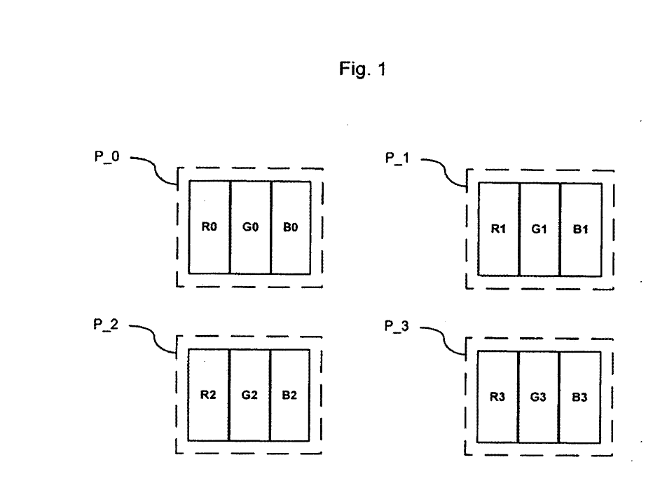

FIG. 1 shows a schematic and not true-to-scale illustration of four pixels P_0, P_1, P_2, and P_3 of a display device according to the present invention, which in the present example is a plasma display. Each pixel P_0, P_1, P_2, and P_3 of the plasma display includes three picture elements R, G, B, as a result of which the pixel P_0 features the picture elements R0, G0, B0, etc., for example. Each picture element R0, G0, B0 is assigned to one of the primary colors red, green, and blue, and, depending on the corresponding activation signal, emits light of the respective color.

On activation of the picture elements R0, G0, B0, . . . with the control signal, i.e. during operation of the plasma display, the picture elements R0, G0, B0, . . . heat up depending, among other things, on the electrical energy delivered to them by means of the control signal. Further, heating of the picture elements R0, G0, B0, . . . can occur due to an elevated ambient temperature or heat energy supplied from somewhere else or the like, which leads to the wear of the picture elements R0, G0, B0, . . . , which is reflected in a reduced electrical/optical conversion efficiency.

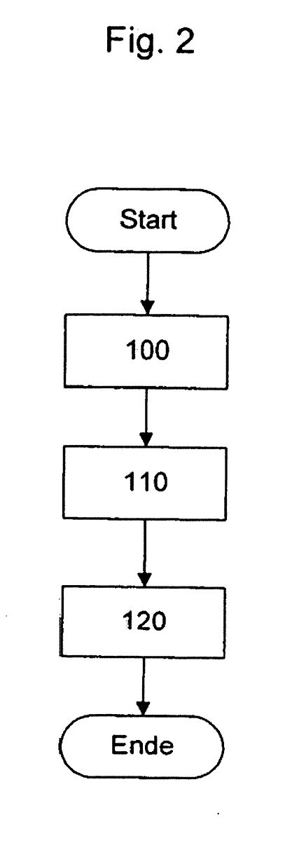

With reference to FIG. 2, a method to detect the temperature-related wear of the picture elements R0, G0, B0, . . . is illustrated. First, in step 100 the temperature of each picture element R0, G0, B0, . . . is determined only on the basis of the electrical energy delivered to it within the framework of the activation with the control signals. For this purpose, for example, a model can be used which considers each picture element R0, G0, B0 . . . alone as a unit, which features a specific heat capacity, and to which energy is delivered by means of the control signal and, among other things, converted into heat in the picture element.

Subsequently, a contribution of the adjacent picture elements R0, G0, B0, . . . to the temperature of the picture element under consideration, preferably in the form of a weighted sum of each temperature of the adjacent picture elements, is determined separately in step 110, preferably for each picture element R0, G0, B0, . . . , . This contribution of the adjacent and/or surrounding picture elements is added to the temperature of the picture element determined in step 100. Accordingly, depending on the temperature difference, this also reduces the temperature of the adjacent picture elements, in particular if they are warmer than the picture element under consideration. That is, cooling the adjacent picture elements by heat transport to the picture element under consideration or other picture elements is likewise taken into account by the method according to the present invention.

By means of step 110 according to the present invention, the heat transport between adjacent picture elements is advantageously taken into account. According to investigations, this is not negligible in particular when one or several picture elements are set at especially bright activation and/or for a long time, and thus become especially heated. This self-heating of the picture elements with bright activation and/or for a long time can at least act upon the directly adjacent picture elements and accelerate their thermally induced wear, even when the adjacent picture elements are not being activated at all, or only weakly.

Subsequently, in step 120, a wear value is determined from the temperature of the picture element by means of the corresponding characteristic curve, for example. The wear value can be used to correct a control signal by which the picture element is activated, for example. In this way, the temperature-dependent wear of the picture element can be effectively compensated.

On calculating the weighted sum in accordance with step 110, the weighting factors may be selected as a function of the distance of the picture element from the adjacent picture element. For example, a contribution of the picture element G0 to the temperature of the picture element B0 gets a greater weighting factor than a contribution of the picture element R1 to the temperature of the picture element B0 because the picture element R1 is farther from the picture element B0 than the picture element G0 (See FIG. 1). Depending on the arrangement of the pixels P_0, P_1, . . . or the picture elements in the plasma display, the distances to be considered for heat transport may vary, so that other distances corresponding to the geometry of the display device may be considered.

The heat conductivity of the substrate, which features the picture elements and is not shown, can likewise be taken into account by correspondingly selecting and/or modifying the described weighting factors, just like the temperature of the picture element under consideration, or a temperature difference between the picture element under consideration and an adjacent picture element.

The selection of special weighting factors can be provided in particular for picture elements that are located at the edge of the display device in order to consider the fact that such picture elements are not surrounded on all sides by adjacent picture elements.

The temperature of the plasma display or the ambient temperature may also be determined when the plasma display is not in operation, because even in the inactivated state the picture elements R0, G0, B0, . . . are subject to temperature-related wear. Additionally, the duration of the phases during which the plasma display is not in operation may be recorded by analyzing data of a real-time clock, for example, which can be provided in a control device of the plasma display that is not shown. In this way, an even more precise determination of the temperature-dependent wear of the picture elements is possible. The temperature of the display device or the ambient temperature in OLED systems may also be considered, because in particular the organic compounds used in OLED systems are subject to non-negligible temperature-induced wear, even when the display device is not in operation.

In general, the temperature of a picture element can be determined periodically, for example at a several-minute interval. The corresponding wear value can also be calculated in the same time raster. That is, for example, every four minutes the temperature may be determined for a specific picture element B0 in accordance with the above steps 100 and 110, and subsequently a wear value may be determined from the four-minute time interval and the determined temperature, which represents the thermally induced wear of the picture element B0 in this time period, and this wear value is then added to a wear value determined previously in the same way.

The temperature determination according to the present invention may be combined with other operating methods for plasma displays or other display devices, in which for example, correction values are likewise determined in a minute raster to correct the control signal, whereby these correction values are generally based only on a control signal and determined without consideration of the thermal stress of the picture elements due to activation or also to ambient conditions.

Such correction values can be modified depending on the determined thermally induced wear values, before the control signal of the plasma display is corrected with them. Thus it is possible to expand conventional compensation methods by taking the thermal wear into account.

The method according to the present invention is especially suited for the combination with the operating method described in the German patent application DE 10 2005 024 769 for plasma displays, which is commonly assigned herewith. There, the wear values determined on the basis of the control signal are transferred periodically at least in part from a volatile primary memory to a non-volatile secondary memory. In this transfer process, the temperature-related wear for the corresponding picture element R0, G0, B0, . . . may also be determined in accordance with steps 100 and 110, and for example added to the wear value that is to be transferred.

The method according to the present invention is not restricted to the use with plasma displays, but may generally be used with all types of display devices when they or their picture elements are subject to thermally induced wear. Apart from an indirect temperature determination of the picture elements by the control signal, several temperature sensors can also be integrated in the substrate accommodating the display device into a regular raster, for example, so that a direct temperature determination of at least different regions of the display device is possible, by means of which the above-described indirect temperature determination can be verified and/or made more plausible and/or expanded, thus further enhancing the precision of the method.

In some variations, a temperature designated as the base temperature of the display device is determined by considering all the control signals of the individual picture elements together over a predefinable time interval, as a result of which a sum of all these control signals is formed in particular. Based on the sum of the control signals, it is possible to derive the electrical energy which is delivered to the picture elements of the display device and which therefore causes heating of the entire display device.

A base temperature determined in this way may, among other things, also be used as the initial value for the determination of the temperature of an individual picture element in accordance with the method described above, whereby on the basis of such an initial value the heat transport between adjacent picture elements is considered by means of the described weighted sum and/or a selection of suitable weighting factors, for example.

Knowing the base temperature calculated from the control signals, which corresponds roughly to the average temperature of the display device, a temperature sensor provided in the form of an electronic component in the display device may be dispensed with, for example. Alternatively, the temperature of the display device determined by means of a temperature sensor can be verified or rendered plausible by means of the calculated base temperature.

A further advantage that arises from the determination of the base temperature and/or a value proportional to the base temperature according to the present invention is that, depending on the base temperature, cooling systems such as fans or the like can be controlled to cool the display device, for example. Since the base temperature or the sum of the control signals on which it is based makes it possible to estimate the electrical energy delivered to the picture elements even at the time of activation of the picture elements, the cooling system can be activated exactly when there is a very bright activation of the picture elements over a few individual images. Thus, the heat produced due to the activation of the picture elements can be removed at an early stage, so that the cooling system can be operated, at least during the time under consideration, with less power than with conventional systems.

The delayed use of the cooling system in conventional systems, which occurs due to the comparatively slow temperature adjustment, may be avoided by taking into account the control signals and/or base temperature derived from them, increasing the performance of the cooling system overall.

For example, the cooling system in one variant of the present invention can already be activated, when over several individual images the average control signal of all the picture elements is larger than a control signal which corresponds to the activation with around 50% of the maximum brightness.

In some variations, a common wear value may be determined for several picture elements. For example, for all the picture elements B0, B1, B2, B3 (FIG. 1), corresponding to the same primary color, as for example blue, of a predefinable number of adjacent pixels P_0, P_1, P_2, P_3, a common wear value may be determined. Thus, in the present example there may be overall three common wear values, whereby each of these wear values indicates the total wear of the picture elements R0, R1, R2, R3 and G0, G1, G2, G3 and B0, B1, B2, B3.

This may result in reduced calculating effort and/or in particular lower memory bandwidth requirements in the calculation and/or storage and/or processing of the wear values, since in contrast to the conventional methods, in the present example twelve separate wear values do not have to be considered any more, but only three wear values that are common to the respective four picture elements of the same primary color.

The separation by primary colors on aggregation of the wear values of several pixels P_0, P_1, . . . described above, is particularly convenient, since the different illuminants that implement the different primary colors as a rule may feature a wear behavior that is different from one another.

That is, preferably wear values of several picture elements R0, R1, . . . of the same primary color, which are each assigned to different pixels P_0, P_1 . . . , are aggregated instead of aggregating the wear values of the picture elements R0, G0, B0 of a single pixel P_0, for example, assigned to the different primary colors.

Generally, in the variant of the method explained above, not only may the thermally induced wear effects be aggregated in the form of a common wear value, but it is in fact also possible to consider only the wear effects of a non-thermal nature arising from the activation with the control signal in the form of a common wear value according to the present invention. Therefore, even the wear values described in the German patent application DE 10 2005 024 769, for example, may be aggregated in

In a combination of the wear values described for example in the German patent application DE 10 2005 024 769 with thermally induced wear values, the aggregation of several such combined wear values is likewise possible.

In another form, an image displayed on the display device is preferably shifted periodically in accordance with a predefinable sequence of shift steps, whereby after performance of all shift steps of the predefinable sequence, the image is preferably again at its initial position on the display device.

For example, for this purpose a control signal assigned to the pixel P_0 or its picture elements R0, G0, B0 is temporarily assigned to the pixel P_1, then to the pixel P_3, then to the pixel P_2, and then finally again to the pixel P_0. The control signals assigned to the other pixels are treated in the same way, so that overall the image displayed on the display device is shifted each time by one pixel to the right, down, left, and up again. The particular assignment to the individual picture elements implementing the color components of a pixel is preserved.

This method, also termed “picture shifting,” or “orbiter,” or “panning,” ensures that control signals corresponding to a very bright activation are distributed successively in time to several adjacent pixels or to their corresponding picture elements, so that the resultant wear is also distributed uniformly to the several pixels or picture elements. That is, the wear effects are smudged and thus produce much less visible burn-in patterns, for example.

The panning described above may be combined together with the method including aggregation of wear values of several pixels. For example, as described, all the wear values of the picture elements R0, R1, R2, R3 may be aggregated as a common wear value, which on panning according to the above described pattern and/or this sequence of shift steps, in which the control signal actually assigned to the pixel or the picture element R0 is assigned successively also to the picture elements R1, R3, and R2, corresponds to the actual wear as it occurs within a sequence of shift steps.

That is, in a preselected sequence of shift steps of the image to be displayed within the framework of panning, a precise determination of common wear values may be made by suitably aggregating several wear values of individual picture elements, so that by the aggregation, at most minimum information and/or precision loss occurs. That is, with the same precision with respect to the determination of the wear values, the number of memory cells required to store the wear values decreases.

The respective shifting of the image to be displayed can occur at intervals of about ten seconds, for example. With pauses of this length between the individual shift steps, the panning may be unnoticeable or barely noticeable by the observer.

Overall, other sequences of shift steps are also conceivable within the framework of panning, whereby in each case the correspondingly involved picture elements may be aggregated in order to form the common wear value according to the present invention.

As already described, a correction value can be determined from the wear values, by which a corrected control signal is determined.

Display devices according to the present invention may feature self-healing effects, which may include not only a decrease in electrical/optical conversion efficiency or other interferences in the maximum display brightness, but also self-healing by the modification of the wear values, in particular their reduction. Such self-healing effects may be observed in particular with TFT display devices.

A further advantageous aspect of the present invention is given by an effective still image recognition, which, among other things, can be used to reduce the brightness with which the display device is activated when still images are displayed, so that undesired burn-in of the still image is avoided.

The still image recognition may be based on the fact that the image 200 to be displayed on the display device (See FIG. 4) may be divided into several image regions 201, 202, 203, 210, . . . , to each of which a plurality of picture elements is assigned.

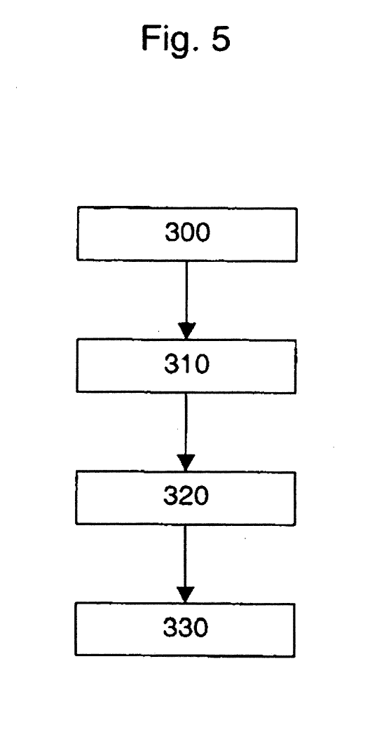

Such image regions 201, 202, 203, 210, . . . , can for example feature around 300×300 picture elements each, which, when the display device is designed as a color display, correspond to 100×100 RGB pixels P_0, P_1, . . . (FIG. 1). For many or all of these regions 201, 202, 203, 210, . . . , a first index may be formed in a first step 300 (FIG. 5). The further steps of the still image recognition according to the present form are explained below by examples using a single image region 201, and are directly applicable to the other image regions 202, 203, 210, . . . .

The first index according to the present form depends on the control signals of the picture elements R0, G0, B0, . . . , assigned to the image region 201. Furthermore, several of the individual images which usually succeed one another at an image frequency of 60 Hz may be considered for the formation of the first index, so that in the consideration of ten individual images, for example, a total of 300×300×10 control signal values are present as initial data for the formation of the index. Alternatively, more or less and/or only one individual image may be considered for formation of the first index. From the 300×300×10 control signal values, the first index may be determined in various ways. An especially simple variant provides that all control signal values are added.

Subsequently, in a further step 310, or after a predefinable dead time and/or after the display of a predefinable number of individual images, a second index may be formed. The second index can be determined by the same principle as the first index.

Subsequently, in step 320 the first index and the second index may be compared, and, depending on the result of this comparison, a still image can subsequently be assumed in step 330 in the presently considered first image region 201.

For example, a still image can be assumed when a difference between the first index and the second index does not exceed a predefinable threshold value. Since in the presently discussed method to determine the indices, these indices correspond to the accumulated brightness of ten individual images or control signal values of the image region 201, in the present description a still image in the image region 201 is assumed when the average brightness of the ten individual images used for the calculation of the first index roughly corresponds to the average brightness of the ten individual images used for the calculation of the second index, that is, when no significant change in brightness has occurred in the image region 201.

A further variant of the indices may occur by forming in each case check sums from the control signal values, for example by one of the methods known per se, whereby the indices in each case correspond to the check sums. In this case a still image can be recognized by the identity of the check sums of the first and/or the second index respectively.

For example, the control signal values added in a known operating method for a specific time may be used for each picture element as input values for the formation of the particular index. These added control signal values are available in the operating method for plasma displays described in the German patent application DE 10 2005 024 769 in the form of so-called primary wear values, for example, and may be determined quite generally by the addition of a temporal sequence of control signal values of the picture element under consideration, for example. In this variant, the first and second index may be determined as a function of the primary wear values.

After recognizing whether a still image is present, a first index and successively a second index may again be determined as described above, and the method is thus repeated. Alternatively, a determined second index of a first still image recognition period can be used as the first index of a subsequent, second still image recognition period, etc.

Along with the described methods to determine the indices, there are also other conceivable methods, which correspondingly reduce the data by the formation of an index based on the control signal values.

The method steps described above with reference to the image region 201 may also be carried out in parallel or sequentially for the further image regions 202, 203, 210, . . . .

A decision on whether a still image is overall present can be made for example with the number of image regions 201, 202, 203, 210, . . . , whose first and second index strongly differ from one another. If for example 80% of the image regions 201, 202, 203, 210, . . . have similar first and second indices, a basically unchanged image content of the image 200 may be assumed, and the display brightness may be reduced in order to prevent burn-in of the identified still image, for example.

The determination of a quota of unchanged image regions allows for reliable still image recognition, for example even when some small partial regions of the image 200, like an upper left corner 201 into which a clock is integrated, for example, change, while the greater part of 202, 203, 210, . . . , of the displayed image 200 remains unchanged.

The sensitivity of still image recognition may further be controlled by using only a predefinable number of high-order bits from the control signals and/or wear values used for the calculation of the index so that the respective low-order bits are not included in the index. Thus, minor changes in the control signal values or wear values, which only affect the low-order bits, do not result in a modified index, so that at least in the image region 201, 202, 203, 210, . . . , under consideration, a “still image” can still be recognized.

Since in the operating method described in the German patent application DE 10 2005 024 769, only the respective high-order bits of a wear value in the form of a so-called transmission value are preferably processed periodically, that is, transmitted to a non-volatile secondary memory, this transmission value may present itself as an initial value for the formation of an index according to the present invention. As with the use of the above mentioned transmission value, low-order bits, which are not transmitted to the secondary memory, remain in the primary memory, the LSB (least significant bit) of the transmission value may be dispensed with in the formation of the index.

That is, the still-image recognition described above can be added to the operating method described in the German patent application DE 10 2005 024 769. The use of still-image recognition as described above with other operating methods for plasma displays or the like is likewise conceivable.

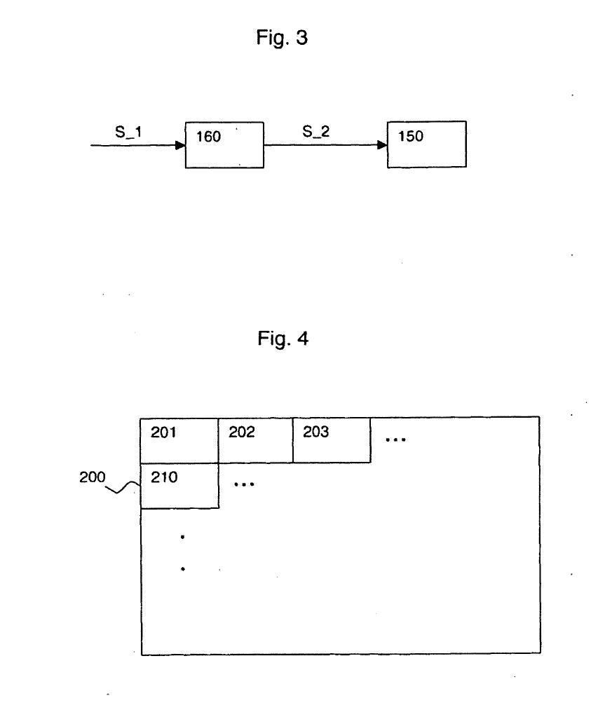

From the above explanations, it is evident that still image recognition according to the present invention may require a small calculating effort and in particular little memory, as for each image region 201, 202, 203, 210, . . . , only a maximum of two index values have to be stored, for example, in order to see and/or identify the change in the relevant image content. In doing so, still image recognition may take place via a processing unit 160 (FIG. 3) that implements the rest of the operating methods of the display device, or via a separate still image recognition unit that may be implemented as software or hardware.

The determination of whether there is a still image is more precise the smaller the individual image regions 201, 202, 203, 210, . . . , are selected.

The methods according to the present invention are not restricted to the use of plasma screens. It is also conceivable to use the methods with display devices which feature organic light-emitting diodes (OLED), operating by the field emission principle (FED) or by the NED (nano-emissive display) principle, or other wear-afflicted picture elements. The methods according to the present invention may also be used with CRT monitors.

FIG. 3 shows a schematic illustration of an embodiment of a display device 150 according to the present invention. A processing unit 160 is assigned to the display device 150, which on the input side is supplied with a video signal S_1 by a video source not shown, like a DVD player, for example. The processing unit 160 is designed, for example, as a microcontroller and/or digital signal processor and/or programmable logic module, in particular as an FPGA (field programmable gate array) and/or as an application specific integrated circuit (ASIC), and may implement the methods described above. In particular, the processing unit 160 may be used to determine the wear values and may make corrections to the control signal derived from the video signal S_1 on the basis of these wear values, for example, as a result of which a corrected control signal S_2 may be determined, with which the display device 150 may finally be controlled. The processing unit 160 may also serve to convert the described panning method.

Further, the implementation of still image recognition according to the present invention is also possible in the processing unit 160. In particular, the still image recognition may also be implemented in display devices that do not feature wear-afflicted picture elements, and control the brightness regulation of a displayed image depending on the recognition of the still image.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A method of operating a display device having a plurality of wear-afflicted picture elements, each picture element being acted upon by a control signal assigned to it, the method comprising determining a wear value for at least one picture element of the plurality of picture elements, the wear value being a measure of the wear of the at least one picture element, the wear value being determined as a function of at least one of the following: the temperature of the at least one picture element and the temperature of at least one adjacent picture element.

2. The method according to claim 1, wherein the temperature is determined as a function of the respective control signal.

3. The method according to claim 1, further comprising determining the contribution of at least one adjacent picture element to the temperature of the at least one picture element in the form of a weighted sum of the temperatures of adjacent picture elements of the plurality of picture elements.

4. The method according to claim 1, further comprising determining the contribution of at least one adjacent picture element to the wear value of the at least one picture element in the form of a weighted sum of the temperatures of adjacent picture elements of the plurality of picture elements.

5. The method according to claim 3, further comprising determining the weighted sum based on at least one of the following weighting factors:
the distance of the at least one picture element to the at least one adjacent picture element;
a physical property of a substrate on which the picture elements of the plurality of picture elements are arranged;
the temperature of the at least one picture element;
the temperature of the at least one adjacent picture element; and
the position of the at least one picture element.

6. The method according to claim 5, wherein the weighted sum is determined based on the heat conductivity of the substrate.

7. The method according to claim 1, further comprising determining the wear value of a picture element of the plurality of picture elements as a function of the temperature of the display device.

8. The method according to claim 7, wherein the temperature of the display device is determined when the display device is deactivated.

9. The method according to claim 8, further comprising determining the duration of phases in which the display device is deactivated.

10. The method according to claim 1, further comprising determining the wear value of a picture element of the plurality of picture elements as a function of ambient temperature.

11. The method according to claim 10, wherein the ambient temperature is determined when the display device is deactivated.

12. A method of operating a display device having a plurality of wear-afflicted picture elements, each picture element being acted upon by a control signal assigned to it, the method comprising:
determining a wear value for at least one picture element of the plurality of picture elements, the wear value being a measure of the wear of the picture element; and
determining a common wear value for the each picture element of the plurality of picture elements.

13. The method according to claim 13, wherein the common wear value is determined as a function of the control signals assigned to the picture elements.

14. The method according to claim 12, further comprising shifting an image displayed on the display device, the image being shifted periodically in accordance with a predefinable sequence of shift steps.

15. The method according to claim 14, wherein the shifting in accordance with a predefinable sequence of shift steps includes returning the image to its original position upon completion of the sequence of shift steps.

16. The method according to claim 14, further comprising providing pause steps between the performance of two successive shift steps, the pause steps ranging from about 1 to 3600 seconds.

17. The method according to claim 14, wherein shifting the image in accordance with the sequence of shift steps includes the following:
shifting the image by a first predefinable number of pixels in a first direction;
shifting the image by a second predefinable number of pixels in a second direction;
shifting the image by a third predefinable number of pixels in a third direction; and
shifting the image by a fourth predefinable number of pixels in a fourth direction.

18. The method according to claim 17, wherein the first, second, third, and fourth predefinable numbers of pixels are each 1 pixel.

19. A display device having a plurality of picture elements, each picture element of the plurality of picture elements being configured to be acted upon by a control signal assigned to it, at least one picture element of the plurality of picture element having a wear value, the wear value being the measure of the wear of the at least one picture element, the wear value being determined as a function of at least one of the following: the temperature of the at least one picture element and the temperature of at least one adjacent picture element.
